(19) United States
(12) Patent Application Publication
(10) Pub. No.: US 2007/0267999 A1
(43) Pub. Date: Nov. 22, 2007

(54) Multi-chemistry chargers

(75) Inventors: Don Buckley, Poway, CA (US); Lance Chandler, Gig Harbor, WA (US); Raymond Goodrich, Saugus, CA (US)

Correspondence Address: WALLACE G. WALTER, 5726 CLARENCE AVE, ALEXANDRIA, VA, 22311-1008, US

(73) Assignee: Poweready

(21) Appl. No.: 10/778,893

(22) Filed: Feb. 13, 2004

Related U.S. Application Data
(60) Provisional application No. 60/447,484, filed on Feb. 13, 2003.

(51) Int. Cl. H02J 7/00

(52) U.S. Cl. 320/112

(57) ABSTRACT

A multi-chemistry charger system includes a charger in electrical connection with an analysis station, a battery port formed with a receiver cup sized to receive and establish electrical connection with battery pack. Charger also is in electrical communication with a network system having network components, such as remote computer or lab equipment, and an external programming center, such as a reprogrammable databank or a remotely located databank capable supplying current, updated battery information and charging characteristics. A wireless interface is also in communication with charger to provide a wireless link to other devices, or to retrieve programming or related data from outside data sources.

### RELATED APPLICATION

This application claims the benefit of priority to United States Provisional Patent Application No. 60/447,484 filed Feb. 13, 2003, and currently co-pending.

### FIELD OF THE INVENTION

The present invention relates generally to a battery charger. More specifically to a device used in the charging of cell batteries used in electronics and computer shut down systems capable of determining the battery cell type, including charge characteristics and chemistry, and providing an optimal charge of the cells.

### BACKGROUND OF THE INVENTION

Battery chargers currently available are typically cell-specific. While this provides for a functional charger, it often results in companies having various battery cell types to own and maintain a separate charger for each battery cell type. This results in the purchase of excessive equipment, and the increased costs of maintaining those rechargeable battery systems.

### DESCRIPTION OF A PREFERRED EMBODIMENT

This invention is a modular system and method for charging several types of chemical cell batteries used in various applications, such as: Fluke portable lab equipment, Tec. Scanners, Motorola, computer central processing units, and specific hospital equipment that uses rechargeable chemical based cell batteries.

The current invention uses a modular system to charge cell batteries such as: NiCd, NiMH, SLA, and Lithium Chemical batteries.

Novelties of the apparatus of the present invention includes, but are not limited to:

Auto recognition for all chemistries with data pin input so that the battery broadcasts data and charge parameters
Data output for analysis or product testing
programmable voltage
programmable current
programmable data protocols (fuel gage)
programmable charge terminations
programmable LEDS/Indicators (LED/LCD/Audible)
Replaceable cops/programmable cups within a standard battery port
network capable for communicating with an array of equipment to provide feedback and status information for remotely located battery packs.
RF/Wireless capabilities for networking.
Encryption (proprietary or 128 key standard) available for ownership control and management of the battery packs.
Battery Conditioning for charging, maintaining and discarding batteries within a battery pack.

The apparatus of the present invention includes the networking opportunity for remote management of patient monitoring, and battery maintenance, and may also provide historical data, and may flag a battery pack for replacement or repair.

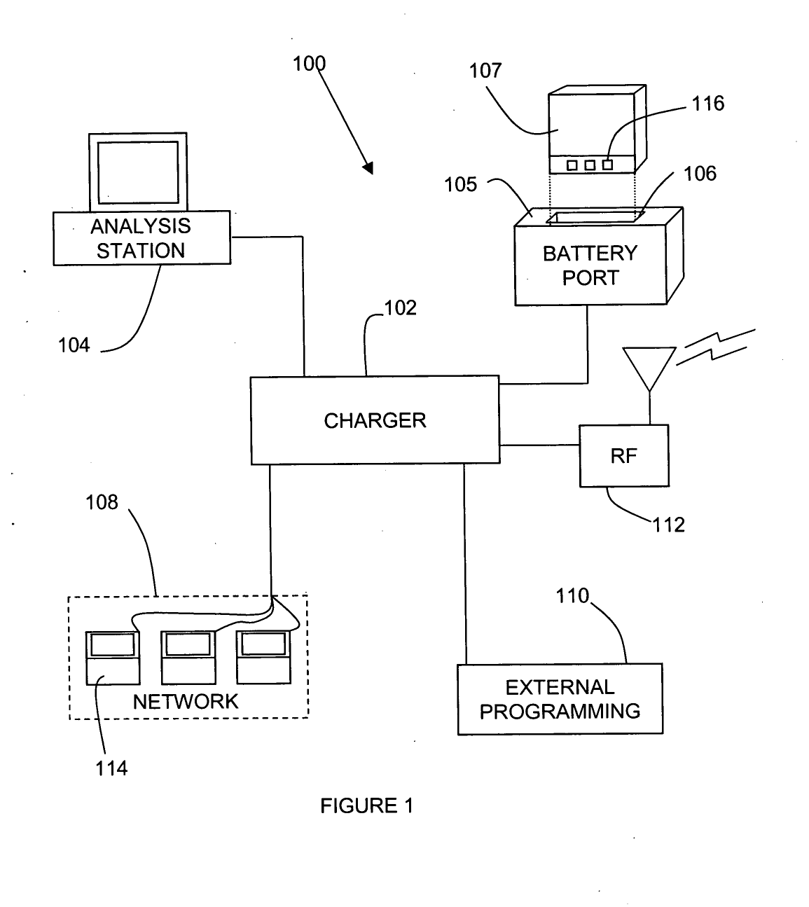

Referring to FIG. 1, a Multi-Chemistry Charger System of the present invention is shown and generally designated 100. Charger System 100 includes a charger 102 in electrical connection with an analysis station 104, a battery port 105 formed with a receiver cup 106 sized to receive and establish electrical connection with battery pack 107. Charger 102 also is in electrical communication with a network system 108 having network components 114, such as remote computer or lab equipment, and an external programming center 110, such as a reprogrammable databank or a remotely located databank capable supplying current, updated battery information and charging characteristics. A wireless interface 112 is also in communication with charger 102 to provide a wireless link to other devices, or to retrieve programming or related data from outside data sources.

Battery pack 107 is formed with a number of electrical contacts 116 positioned on the pack 107 to establish electrical connection with similar contacts (not shown) located within receiver cup 106. In operation, battery pack 107 is removed from its equipment (not shown) and inserted into cup 106 where contacts 116 establish electrical connection with battery port 105. These contacts 116 provide for several functions.

First of all, the contacts 116 may be connected to a serial data channel for accessing information from a microcontroller, CPU or ASIC within the battery pack 107. Also, these contacts 116 provide for the electrical measurement of battery pack 107 voltage, and may provide measurement of individual cells within the battery pack 107. Also, historical data may be read from the battery pack, such as last charge period, prior charging history, battery age, condition, etc.

External programming station 110 provides charging requirements and other information to charger 102 which in turn, in accordance with battery type identified by accessing battery pack 107, provides a proper battery charge for the type of cells within the battery pack 107. The information regarding the charging characteristics of the battery pack 107 may be dependant on the following items, for example, manufacturer, age of cells, voltage of each cell and the battery pack, chemistry of the cells, and other factors. This criteria may be stored in a memory in charger 102, or may be downloaded from external programming center 110, retrieved from network 108, or received from RF linke 112, as well as calculated or provided by analysis station 104.

Battery analysis station 104 may retrieve information for each battery pack 107 introduced into the system 100, and may provide charging information to charger 102. In a preferred embodiment, charger 102 receives identifying infromation from battery pack 107, provides that information to analysis station 104, which in turn provides charging profiles for the battery pack 107. These profiles are either calculated within station 104, accessed from external programming station 110 or another data source, or a combination of calculation and database access.

In operation, a battery pack 107 may be identified, charged, and deployed using the system of the present invention. Once deployed, the battery pack 107 may be monitored by network 108 or RF link 112 for battery charge levels, operation levels, and fault conditions flagging a maintenance or replacement notice via analysis station 104 or remotely conveyed to field repair technicians through RF link 112.

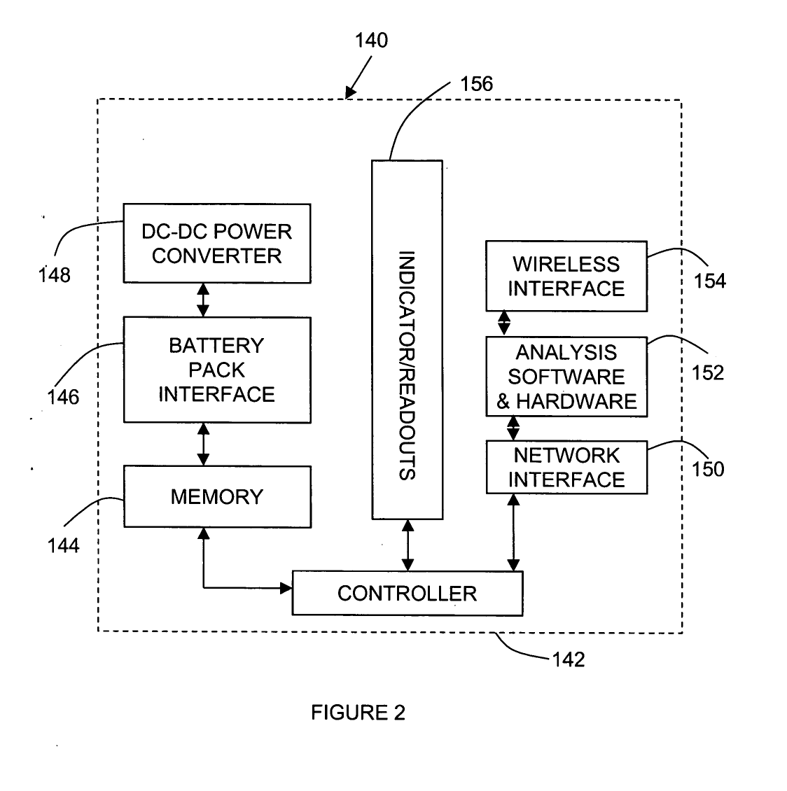

Referring to FIG. 2, the multi-chemistry charger of the present invention is shown in a single-chassis embodiment, wherein all components are contained in a modular fashion with a single chassis. More specifically, charger system 140 includes a DC-DC power converter 148 providing power to the system 140. Controller 142 provides the operational control of system 140 and receives and provides information to and from memory 144 containing battery information and chemistry and charging profiles, for example, and battery pack interface 146. Indicators and readouts 156 provide user interface capability, and a network interface 150, analysis software and haredware 152, along with wireless interface 154 provide input-output capability to system 140 that may be contained in a single chassis 142.

In a preferred embodiment, each of the components within chasis 142 may be modularly constructed, resulting in the ability to customize a multi-chemistry charging system for virtually any application. Further, receivers 106 may correspond to particular manufactures and models of battery packs, and these receivers may be replacable with other receivers corresponding to other battery packs. In this manner, virtually any battery pack 107, regardless of physical dimensions or chemical composition, may be monitored, charged, and recharged using the system of the present invention.

1. A multi-chemistry charger system, comprises:
a charger;
an analysis station in electrical connection with said charger;
a battery port formed with a receiver cup sized to receive and establish electrical connection with a battery pack;
a means for analyzing said battery pack to determine its charging characteristics; and
a means for charging said battery pack.
